(19) United States
(12) Patent Application Publication
(10) Pub. No.: US 2008/0038519 A1
(43) Pub. Date: Feb. 14, 2008

(54) Polymer Sheeting

(76) Inventors: Frederik W.B. Hoolhorst, Bergen op Zoom (NL); Frans Adriaansen, Bergen op Zoom (NL)

Correspondence Address: CANTOR COLBURN, LLP, 55 GRIFFIN ROAD SOUTH, BLOOMFIELD, CT, 06002, US

(21) Appl. No.: 11/463,927

(22) Filed: Aug. 11, 2006

(51) Int. Cl. B32B 3/20

(52) U.S. Cl. 428/188; 428/166

(57) ABSTRACT

Disclosed herein is polymer sheeting articles. In one embodiment a multiwall sheet is disclosed. The multiwall sheet comprises: a top layer, a bottom layer, a web disposed between the top layer and the bottom layer, and two or more air gaps in a perpendicular line between the top layer and the bottom layer. The multiwall sheet exhibits a U-value of less than or equal to 2.3 W/m²K, and has an AgUT ratio of greater than or equal to about 0.168.

### TECHNICAL FIELD

The present disclosure relates generally to polymer sheeting.

### BACKGROUND

In the construction of naturally lit structures (e.g., greenhouses, pool enclosures, conservatories, stadiums, sunrooms, and so forth), glass has been employed in many applications as transparent structural elements, such as, windows, facings, and roofs. However, polymer sheeting is replacing glass in many applications due to several notable benefits.

One benefit of polymer sheeting is that it exhibits excellent impact resistance compared to glass. This in turn reduces maintenance costs in applications wherein occasional breakage caused by vandalism, hail, contraction/expansion, and so forth, is encountered. Another benefit of polymer sheeting is a significant reduction in weight compared to glass. This makes polymer sheeting easier to install than glass and reduces the load-bearing requirements of the structure on which they are installed.

In addition to these benefits, one of the most significant advantages of polymer sheeting is that it provides improved insulative properties compared to glass. This characteristic significantly affects the overall market acceptance of polymer sheeting as consumers desire structural element with improved efficiency to reduce heating and/or cooling costs.

Although the insulative properties of polymer sheeting are greater than that of glass, there is a continuous demand for further improvement. This is especially the case for sheeting materials comprising a total thickness of less than about 32 mm, wherein at these relatively small thicknesses it is difficult to provide acceptable insulative capacity.

Therefore, what is needed in the art are polymer sheeting articles having a total thickness of less than about 32 mm that exhibit improved insulative properties.

### BRIEF SUMMARY

Disclosed herein are polymer sheeting articles and uses thereof. In one embodiment a multiwall sheet is disclosed. The multiwall sheet comprises: a top layer, a bottom layer, a web disposed between the top layer and the bottom layer, and two or more air gaps in a perpendicular line between the top layer and the bottom layer. The multiwall sheet exhibits a U-value of less than or equal to 2.3 W/m²K, and has an AgUT ratio of greater than or equal to about 0.168.

In another embodiment, a multiwall sheet comprises: a top layer, a bottom layer, a first rib disposed between and connected to the top layer and to the bottom layer, a second rib disposed between and connected to the top layer and the bottom layer, a web connected to the first rib and connected to the second rib, and a number of air gaps in a perpendicular line between the top layer and the bottom layer. The web has a wall thickness that is less than or equal to about 0.05 mm. The multiwall sheet comprises a total thickness, and wherein the ratio of the total thickness to the number of air gaps is less than or equal to about 2.5.

In yet another embodiment, a multiwall sheet comprises: a top layer, a bottom layer, a first rib disposed between and connected to the top layer and to the bottom layer, a second rib disposed between and connected to the top layer and the bottom layer, a web connected to the first rib and connected to the second rib, a total thickness that is less than or equal to about 32 mm, and two or more air gaps in a perpendicular line between the top layer and the bottom layer. The multiwall sheet exhibits a U-value of less than or equal to about 2.3 W/m²K, and has an AgUT ratio of greater than or equal to about 0.168.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is a partial front view of an exemplary multiwall sheet 2.

FIG. 2 is an exemplary table illustrating the U-values of several multi-wall polymer sheeting materials having a total thickness of 10 mm.

### DETAILED DESCRIPTION

Disclosed herein is polymeric sheeting that offers improved insulative properties compared to those previously available. To be more specific, polymer sheeting is disclosed that comprises horizontal webs within the cell structure of the sheeting. These webs provide an increased number of air gaps across the thickness of the sheet, which provides a noteworthy improvement in the sheets insulative properties.

Further, this achievement is facilitated through the development of methods for forming polymer sheeting having webs having very small wall thicknesses. Overcoming this challenge enabled the formation of sheeting having the increased number of air gaps and providing the air gaps with sufficient dimensions to provide good insulation. To be more specific, the polymer sheeting products disclosed comprise an overall thickness to air gap ratio of greater than or equal to about 0.250, and exhibit a thickness to U-value ratio of greater than about 0.232. To be specific, the U-value is the amount of thermal energy that passes across 1 square meter of the sheet 2 at a temperature difference between both sheet sides of 1° K. The U-value can be determined according to EN 675 and DIN EN 12667/12664. The U-value is calculated according to the following formula (I):

U=1/1/αᵢ+1/χ+1/αₐ (I)

wherein: χ=λ/s
λ=thermal conductivity
s=sheet thickness
(1/αᵢ)=thermal transition resistance value inside
(1/ αₐ)=thermal transition resistance value outside

### The U-value was calculated by using the thermal transition resistance values called in the Norm NEN 1068 (Year 2001), wherein (1/αᵢ) is 0.13 square meters Kelvin per watt (m²K/W) and (1/αₐ) is 0.04 m²K/W.

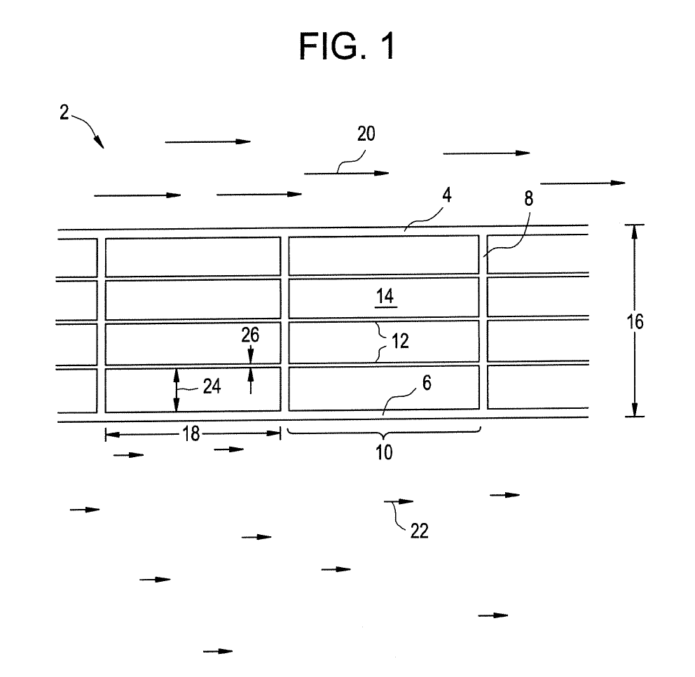

Referring now to FIG. 1, a partial front view of an exemplary multiwall sheet 2 is illustrated, wherein the sheet 2 comprises a top layer 4 and a bottom layer 6 that are connected by ribs 8. The top layer 4 and the bottom layer 6 are generally parallel with respect to each other. The ribs 8 are generally disposed between, and normal to, the top layer 4 and the bottom layer 6.

The sheet 2 (hereinafter also referred to as multiwall sheet) comprises multiple cells 10 that are defined by adjacent ribs 8 and the top layer 4 and bottom layer 6. Each sheet 2 can comprise a plurality of cells 10. Each cell 10 is divided into a plurality of air gaps 14 by webs 12 that connect to adjacent ribs 8. The webs 12 are disposed generally parallel with the top layer 4 and the bottom layer 6 (e.g., horizontal), and comprise a wall thickness 26. The air gaps comprise a gap height 24.

The total thickness 16 of the sheet 2 is generally less than or equal to about 32 mm, or more specifically, less than or equal to about 16 mm, and even more specifically, less than or equal to about 12 mm, however generally greater than or equal to about 8 mm. In the present embodiment however, the sheet has a thickness of 10 mm.

Each cell 10 can comprise a width of about 10 mm, however any width can be employed that is capable of providing sufficient stiffness for the intended use (e.g., as a roofing or sheeting product). To be more specific, when assembled, the sheet 2 can be exposed to a variety of forces caused by snow, rain, wind, and such. Therefore, the sheet is desirably capable of withstanding these forces without failing (e.g., buckling, cracking, bowing, and so forth). The specific dimensions of the final sheet 2 (e.g., total width, length and thickness), as well as the thicknesses of the top layer 4, bottom layer 6, and ribs 8, will be chosen such that the sheet 2 can withstand these forces. It is noted that the primary purpose of the webs 12 are for creating the air gaps 14 and not for increasing mechanical properties due to their exceptionally small wall thickness 26.

In use, referring again to FIG. 1, when exposed to external conditions 20 (e.g., hot temperatures, cold temperatures, and so forth) the air gaps 14 are capable of insulating the internal conditions 22 (e.g., a controlled environment) therefrom, thereby providing excellent insulative properties. To be more specific, the sheet 2 provides improved insulative properties due to the plurality of air gaps 14 disposed within each cell 10. However, to be efficient, the gap height 24 of the air gaps 14 should be as large as possible within the constraints of the overall dimensions and configuration of the sheet 2. Moreover, if the gap height is too small (e.g., less than about 1.6 mm) the air gap 14 will be less efficient than a larger air gap 14 at providing insulation. To that end, alternative embodiments can be configured to have greater than four air gaps 14 (e.g., five air gaps 14, six air gaps 14, and so forth).

Further, to achieve gap heights 24 greater than or equal to about 2.0 mm, the webs 12 were produced at an extremely small wall thickness 26, that are generally less than or equal to about 0.003 in. (0.076 mm). In the specific embodiment illustrated in FIG. 1, the web's wall thicknesses 26 are equal to about 0.002 in (0.05 mm).

The sheet 2 is characterized using several measures. The first characterization is the ratio of the sheet's total thickness 16 to the sheet's number of air gaps 14. For the specific sheet 2 illustrated in FIG. 1, this ratio is equal to 2.5, which is calculated by dividing the total thickness 16 in millimeters (e.g., 10 mm) by the number of air gaps 14 (e.g., 4 air gaps). It is also envisioned however that a sheet can be produced that comprises a total thickness of 8 mm having four air gaps 14, which would yield a ratio of 2.0. Therefore all sheets envisioned having a total thickness 16 of less than or equal to about 32 mm and greater than or equal to about 8 mm will have a ratio of total thickness to number of air gaps of less than or equal to 2.5, or, more specifically, about 2.0 to about 2.5, with a ratio of down to about 1.75 believed possible.

A second measure employed to characterize the sheet 2 is an AgUT ratio according to the following formula (I):

$$AgUT ratio = \frac{{A}_{G}}{( {U}_{V} ) ( {T}_{s} )} \qquad ( I )$$

wherein: AG=number of air gaps in the vertical direction
Uᵥ=U-value in (W/m²K)
Tₛ=sheet thickness in (mm)
   For the specific sheet 2 illustrated in FIG. 1, this ratio is equal to about 0.17, which is calculated by dividing the number of air gaps (e.g., the number of air gaps between the top layer and the bottom layer in a line perpendicular to the top layer and the bottom layer; in other words, with these layers disposed horizontally, the number of air gaps in vertical direction (e.g., 4)) by the multiplication of the U-value (e.g., 2.3 W/m²K) times the sheet thickness (e.g., 10 mm).

As the total thickness 16 of a sheet 2 increases, the sheet 2 can comprise a greater number of air gaps 14 (e.g., greater than four air gaps), which will provide even further insulation. Therefore, the U-value is expected to remain equal to or lower than 2.3 W/m²K for all sheets having a total thickness of about 8 mm to about 32 mm. Therefore, it can be stated that all sheets 2 having a thickness of less than or equal to about 32 mm and greater than or equal to about 8 mm will exhibit an AgUT ratio of greater than or equal to about 0.168

A third measure that can be employed to characterize the sheet 2 is that any web 12 disposed between the top layer 4 and the bottom layer 6 comprises a wall thickness 26 that is less than or equal to about 0.003 in (0.076 mm), or even more specifically less than or equal to about 0.002 in (0.05 mm).

A fourth measure that can be employed to characterize the sheet 2 is that any air gap 14 disposed between the top layer 4 and the bottom layer 6 is to comprise a gap height 24 of greater than or equal to about 1.76 mm, which is the gap height 24 of a sheet 2 having a sheet thickness of about 8 mm.

A major hurdle was overcome to be capable of forming webs 12 having wall thicknesses 26 less than or equal to 0.003 (0.076 mm). The manufacturing process and tooling were modified such that the webs 12 would not extensively deform once the profile of the sheet 2 exited the extrusion die. To be more specific, during the process of profile extrusion, the molten polymer exits the profile die in the general shape of the profile and is then successively cooled. However, when a profile is formed comprising a web 12 using this method, the web 12 can distort under its own weight when the molten profile exits the die. To alleviate this problem, a pressure-assisted extrusion method inflates the air gaps with air as the extrusion is produced, which supports the web 12 as the profile (e.g., sheet 2) is extruded.

The pressure-assisted profile extrusion process generally comprises: forming a multiwall sheet having an air gap and a web, providing a pressurized gas to the air gap, supporting the web, and cooling the web. To be more specific, a profile extrusion process is utilized to form a profile extrusion using a profile die (e.g., an extrusion die configured to manufacture the profile shape) having an air gap and a web. During extrusion of the multiwall sheet, pressurized gas (e.g., air) is introduced into each of the air gaps 14 to support the web 12 as it exits from the die and is conveyed as it cools and solidifies.

In one exemplary manufacturing process, a single screw extruder is employed to extrude a polycarbonate melt through a profile die that is capable of forming a profile having a cross-section similar to that of the sheet 2 illustrated in FIG. 1. The screw speed of the extruder and the temperatures of the process (e.g., extruder temperature, die temperatures, and so forth) are controlled such that temperature of the polymer melt is controlled so that the melt will solidify relatively quickly once it exits the die, compared to alternative processes wherein the polymer melt comprises a greater melt temperature.

The die comprises a configuration that is capable of forming the desired profile of FIG. 1 and provides pressurized air to each air gap 14. Exemplary die designs are torpedo designs, cross-head designs, and so forth. The air is supplied to the air gaps 14 using air holes (e.g., 1.0 mm (0.040 in) in diameter) disposed through the face of the die in positions that are operable communication with each air gap. The air holes are individually connected to an air pressure control source that is capable of controlling the air pressure to about ±0.01 mm/Hg, or to an even more precise increment. The pressure delivered to each air gap 14 will depend upon the pressure drop between the air pressure control unit and the die face, the temperature of the extrudate, the volume of the air gap 14, line speed, and other variables. Generally, the air pressure delivered to adjacent air gaps 14 can be the same or similar. Further, the temperature air can be controlled to increase the rate of cooling of the sheet 2, delay cooling to avoid hazing, or to ensure consistency along the extrusion run.

Once the sheet 2 has been extruded, it can be conveyed a distance in ambient air so that a portion of the heat is removed before the sheet 2 physically contacts any supporting, conveying, cooling, or other apparatus' to ensure a non-blemished outer surface is maintained. Thereafter, the sheet 2 travels through a sizing apparatus wherein it is cooled below its glass transition temperature (e.g., about 297° F. (147° C.)).

Once cooled, the sheet 2 is reheated to a temperature that is below the glass transition temperature (e.g., Tg=145° C.) to alleviate any stresses and/or hazing. After the sheet is reheated, it is can be subjected to secondary operations such as, but not limited to, printing, annealing, application of protective layers and/or masking layers, trimming, decorating, and additional processes. Thereafter, the sheet 2 is cut to length, utilizing, for example, a heated knife or an indexing saw. Once cut, the sheet 2 can be packaged.

The extruder employed will be sized based on the desired production rate. The cooling apparatus can be sized (e.g., length) to remove heat from the extrudate in an expeditious manner without imparting haze, which can be imparted by cooling a polycarbonate extrusion rapidly. Therefore, the cooling apparatus can operate at relatively warmer temperatures (e.g., greater than or equal to about 100° F. (39° C.), or, more specifically, greater than or equal to 125° F. (52° C.)), rather than cooler temperatures (e.g., less than 100° F. (39° C.), or, more specifically, less than or equal to about 75° F. (24° C.)), to reduce hazing. If warmer temperatures are employed, the length of the cooling apparatus can be increased to allow ample time to reduce the extrudate's temperature below its glass transition temperature. The size of the extruder, cooling capacity of the cooling apparatus and cutting operation can be capable of producing the sheet 2 at a rate of greater than or equal to about 5 feet per minute (fpm). However, production rates of greater than about 10 fpm, or even greater than about 15 fpm, are desired.

Coextrusion methods and/or coating methods can also be employed during the production of the sheet 2 to supply differing polymers to any surface portion of the sheet's geometry, to improve and/or alter the performance of the sheet, and/or to reduce raw material costs. In one embodiment, a coextrusion process can be employed to add an aesthetic colorant to the top layer 4. The coating(s) can be disposed on any of the sheet's surfaces to improve the sheet's performance and/or properties. Exemplary coatings or coextrusion layers can comprise antifungal coatings, hydrophobic coatings, hydrophilic coatings, light dispersion coatings, anti-condensation coatings, scratch resistant coatings, ultraviolet absorbing coatings, light stabilizer coatings, and the like. It is to be apparent to those skilled in the art of coextrusion that a myriad of embodiments can be produced utilizing the coextrusion process.

The sheet 2 can be formed from polymeric materials, such as thermoplastics and thermoplastic blends. Exemplary thermoplastics include polyalkylenes (e.g., polyethylene, polypropylene, polyalkylene terephthalates (such as polyethylene terephthalate, polybutylene terephthalate)), polycarbonates, acrylics, polyacetals, styrenes (e.g., impact-modified polystyrene, acrylonitrile-butadiene-styrene, styrene-acrylonitrile), poly(meth)acrylates (e.g., polybutyl acrylate, polymethyl methacrylate), polyetherimide, polyurethanes, polyphenylene sulfides, polyvinyl chlorides, polysulfones, polyetherketones, polyether etherketones, polyether ketone ketones, and so forth, as well as combinations comprising at least one of the foregoing. Exemplary thermoplastic blends comprise acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleic anhydride/acrylonitrile-butadiene-styrene, polyether etherketone/polyethersulfone, polyethylene/nylon, polyethylene/polyacetal, and the like. However, in the specific embodiment illustrated, it is envisioned a polycarbonate material is employed, such as those designated by the trade name Lexan®, which are commercially available from the General Electric Company, GE Plastics, Pittsfield, Mass.

Additives can be employed to modify the performance, properties, or processing of the polymeric material. Exemplary additives comprise antioxidants, such as, organophosphites, for example, tris(nonyl-phenyl)phosphite, tris(2,4-di-t-butylphenyl)phosphite, bis(2,4-di-t-butylphenyl)pentaerythritol diphosphite or distearyl pentaerythritol diphosphite, alkylated monophenols, polyphenols and alkylated reaction products of polyphenols with dienes, such as, for example, tetrakis[methylene(3,5-di-tert-butyl-4-hydroxyhydrocinnamate)]methane, 3,5-di-tert-butyl-4-hydroxyhydrocinnamate octadecyl, 2,4-di-tert-butylphenyl phosphite, butylated reaction products of para-cresol and dicyclopentadiene, alkylated hydroquinones, hydroxylated thiodiphenyl ethers, alkylidene-bisphenols, benzyl compounds, esters of beta-(3,5-di-tert-butyl-4-hydroxyphenyl)-propionic acid with monohydric or polyhydric alcohols, esters of beta-(5-tert-butyl-4-hydroxy-3-methylphenyl)-propionic acid with monohydric or polyhydric alcohols; esters of thioalkyl or thioacyl compounds, such as, for example, distearylthiopropionate, dilaurylthiopropionate, ditridecylthiodipropionate, amides of beta-(3,5-di-tert-butyl-4-hydroxyphenyl)-propionic acid; fillers and reinforcing agents, such as, for example, silicates, fibers, glass fibers (including continuous and chopped fibers), mica and other additives; such as, for example, mold release agents, V absorbers, stabilizers such as light stabilizers and others, lubricants, plasticizers, pigments, dyes, colorants, anti-static agents, blowing agents, flame retardants, impact modifiers, among others.

The specific polymer chosen will be capable of providing sufficient light transmission. To be more specific, the polymer will be capable of providing a transmittance of greater than or equal to about 80%, or, even more specifically, greater than or equal to about 85%, as tested per ASTM D-1003-00 (Procedure B, Spectrophotometer, using illuminant C with diffuse illumination with unidirectional viewing).

wherein transmittance is defined as:

$$\% T = ( \frac{I}{{I}_{O}} ) \times 100 \% \qquad ( II )$$

wherein: I=intensity of the light passing through the test sample
Iₒ=Intensity of incident light

In addition to transmittance, the polymeric material can be chosen to exhibit sufficient impact resistance such that the sheet is capable of resisting breakage (e.g., cracking, fracture, and the like) caused by impact (e.g., hail, birds, stones and so forth). Therefore, polymers exhibiting an impact strength greater than or equal to about 7.5 foot-pounds per square inch, ft-lb/in² (4.00 joules per square centimeter, J/cm²), or more specifically, greater than about 10.0 ft-lb/in² (5.34 J/cm²) or even more specifically, greater than or equal to about 12.5 ft-lb/in² (6.67 J/cm²) are desirable, as tested per ASTM D-256-93 (Izod Notched Impact Test). Further, desirably, the polymer has ample stiffness to allow for the production of a sheet that can be employed in applications wherein the sheet is generally supported and/or clamped on two or more sides of the sheet (e.g., clamped on all four sides), such as in greenhouse applications comprising tubular steel frame construction. Sufficient stiffness herein is defined as polymers comprising a Young's modulus (e.g., modulus of elasticity) that is greater than or equal to about 200,000 pounds per square inch, psi (14,061 kilograms per centimeter squared (kg/cm²)), or more specifically, greater than or equal to about 250,000 psi (17,577 kg/cm²), or even more specifically, greater than or equal to about 300,000 psi (21,092 kg/cm²).

### EXAMPLES

A multiwall polymer sheet 2 was manufactured using a 150 mm (6.0 in) single screw extruder manufactured by OMIPA Inc. The extruder was connected to a profile die configured to produce a sheet 2 extrudate comprising a 10 mm thickness having a cross-section similar to that illustrated in FIG. 1. The width of the sheet was 2,100 mm.

The profile die was configured with 1.0 mm (0.040 in) air holes disposed in the die face for providing pressurized air to the air gaps 14. The air holes were fluidly connected to an air pressure controller produced by Kobold Inc., which was capable of controlling air pressure to about 120 mm/Hg (millimeters of mercury).

Downstream equipment comprised a custom sizing apparatus having cooled upper and lower polished stainless steel plates. The extrudate was conveyed utilizing an OMIPA roller puller, and cut thereafter using an OMIPA hot knife.

During operation, an extrusion grade polycarbonate (e.g., Lexan® SD-1318 112) was utilized. The polymer was dried prior to use in a desiccant dryer to reduce the moisture content to below 0.05% and introduced to the extruder. The melt temperature was controlled to about 260° C. (500° F.) and the line speed was set at about 20 m/min (meters per minute). At these conditions, the air gaps 14 were provided with air at about 20 mm/Hg to support the webs 12 therein. Sheets 2 were produced, sized, and cut to a length of 6,000 mm.

The sheets 2 were then performance tested. The first test conducted was light transmission per EN 410-98, which yielded a transmittance of 95%. The second test conducted was impact testing, which yielded an impact resistance of greater than or equal to 21 m/s (meters per second) using 20 mm diameter projectiles. Third, the weight per unit area of the sheet was calculated per unit area, which was equal to about. Lastly, the U-value of the sheet 2 was calculated according to EN 675 and DIN EN 12667/12664 using a heat flow meter. The U-value was determined to be about 2.3 W/m²K.

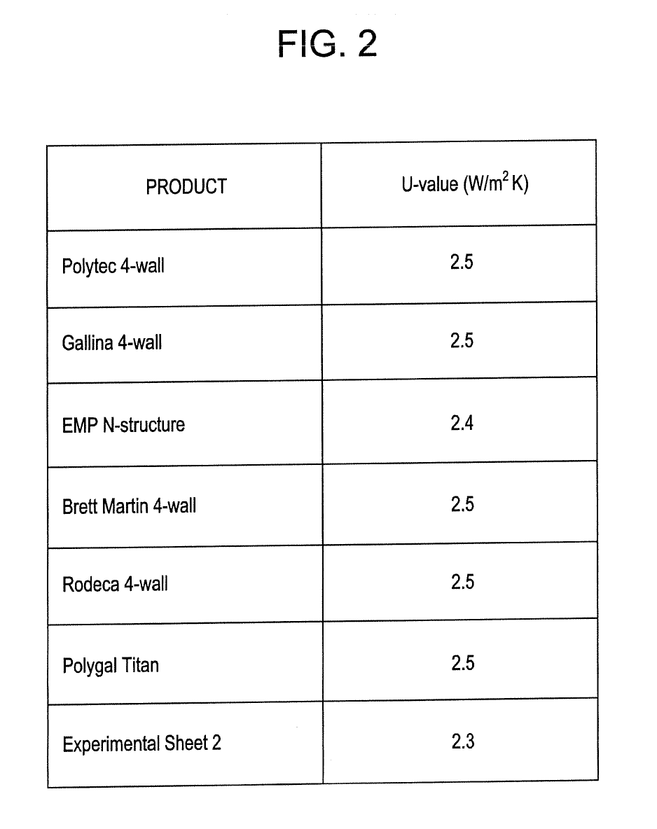

Comparing the sheet 2 to other polymeric sheeting products, the insulative properties of the sheet 2 comprising webs 12 exhibited superior performance, as illustrated in FIG. 2. Referring now to FIG. 2, an exemplary table illustrates the U-values of several multi-wall polymer sheeting materials having a total thickness of 10 mm. As can be seen in the table, the experimental sheet 2 exhibits greater insulative capacity (a lower U-value) than the alternative products that do not have webs 12 or four air gaps 14.

To be specific, the sheet 2 produced had a total thickness of 10 mm and comprised four air gaps 14, which yielded total thickness 16 to number of air gaps 14 ratio that was within a range comprising greater than or equal to 2.0 and less than or equal to 2.5. Further, from the test results, the sheet 2 exhibited a total thickness 16 to U-value ratio that was less than or equal to 4.3. Also, the sheet also comprised webs having a wall thickness that was less than or equal to about 0.002 in (0.05 mm), and comprised a gap height 24 that was greater than or equal to about 1.76 mm, (e.g., 2.0 mm).

Although specifically discussed with relation to naturally lit structures (e.g., greenhouses, sun-rooms, and pool enclosures), polymeric sheeting can be envisioned as being employed in any application wherein a polymer sheet is desired having a multiwall design. Exemplary applications comprise, sunroofs, canopies, shelters, windows, lighting fixtures, sun-tanning beds, stadium roofing, and so forth.

As discussed herein, polymeric multiwall sheeting comprising webs 12 enable the formation of sheets having a greater number of air gaps 14. For example, it was unexpectedly discovered that it is possible to produce a sheet providing 4 air gaps within a sheet thickness of only 10 mm. The result of this development is improved insulative properties, which corresponds to and increase in the efficiency of controlled environments (e.g., office buildings). This is especially desirable as consumers desire structural element with improved efficiency to reduce heating and/or cooling costs. For example, sheets having a U-value of less than or equal to 2.3 W/m²K, which can result in measurable energy savings. For example, when calculating according to the guidelines given in the DIN standard 4701(Year 2003), an average annual saving of 0.9 to 1.3 liters of oil or 1.0-1.5 cubic meters (m³) of gas per square meter (m²) of glazing area will be obtained by decreasing the U-value by 0.1 W/m²·K. Hence, a change of U-value from 2.4 W/m²K to 2.3 W/m²K is a highly significant.

In addition, by reducing the wall thickness of the webs, the inventors hereof have also reduced the weight of the sheeting per unit area.

For clarity and consistency, unless defined otherwise, technical and scientific terms used herein have the same meaning as is commonly understood by one of skill in the art to which this invention belongs. The terms “first”, “second”, and “the like”, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about 25 wt. %, or, more specifically, about 5 wt. % to about 20 wt. %, ” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., “the element(s)”, includes one or more elements). Furthermore, as used herein, “combination” is inclusive of blends, mixtures, alloys, reaction products, and the like.

While the sheeting have been described with reference to exemplary embodiments, it will be understood by those skilled in the art that various changes may be made and equivalents may be substituted for elements thereof without departing from the scope. In addition, many modifications may be made to adapt a particular situation or material to the teachings of the sheeting without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A multiwall sheet, comprising:
a top layer;
a bottom layer;
a web disposed between the top layer and the bottom layer; and
two or more air gaps in a perpendicular line between the top layer and the bottom layer;
wherein the multiwall sheet exhibits a U-value of less than or equal to 2.3 W/m²K, and has an AgUT ratio of greater than or equal to about 0.168.

2. The multiwall sheet according to claim 1, wherein the ratio of the total thickness to the number of air gaps is greater than or equal to about 2.0 and less than or equal to about 2.5.

3. The multiwall sheet according to claim 1, wherein the multiwall sheet is formed from polycarbonate.

4. The multiwall sheet according to claim 3, wherein the polycarbonate comprises an ultraviolet light absorber.

5. The multiwall sheet according to claim 1, comprising a total thickness that is less than or equal to about 32 mm.

6. The multiwall sheet according to claim 1, wherein the multiwall sheet has a ratio of total thickness to U-value of greater than or equal to about 4.3.

7. A multiwall sheet, comprising:
a top layer;
a bottom layer;
a first rib disposed between and connected to the top layer and to the bottom layer;
a second rib disposed between and connected to the top layer and the bottom layer;
a web connected to the first rib and connected to the second rib, wherein the web has a wall thickness that is less than or equal to about 0.05 mm; and
a number of air gaps in a perpendicular line between the top layer and the bottom layer,
wherein the multiwall sheet comprises a total thickness, and wherein the ratio of the total thickness to the number of air gaps is less than or equal to about 2.5.

8. The multiwall sheet according to claim 7, wherein the ratio of the total thickness to the number of air gaps is greater than or equal to about 2.0 and less than or equal to about 2.5.

9. The multiwall sheet according to claim 7, wherein the multiwall sheet has a U-value that is less than or equal to 2.3 W/m²K.

10. The multiwall sheet according to claim 7, wherein the total thickness is equal to or less than about 32 mm.

11. The multiwall sheet according to claim 7, wherein the multiwall sheet has an AgUT ratio of greater than or equal to about 0.168.

12. The multiwall sheet according to claim 7, further comprising a gap height of greater than or equal to about 1.76 mm.

13. The multiwall sheet according to claim 7, wherein the multiwall sheet is formed from polycarbonate.

14. The multiwall sheet according to claim 13, wherein the polycarbonate comprises an ultraviolet light absorber.

15. The multiwall sheet of claim 7, further comprising a coating and/or coextrusion layer disposed on the top layer and/or bottom layer.

16. The multiwall sheet of claim 15, wherein the coating and coextrusion layer are, independently chosen from the group consisting of antifungal coatings, hydrophobic coatings, hydrophilic coatings, light dispersion coatings, anti-condensation coatings, scratch resistant coatings, ultraviolet absorbing coatings, light stabilizer coatings, and combinations comprising at least one of the foregoing.

17. A multiwall sheet, comprising:
a top layer;
a bottom layer;
a first rib disposed between and connected to the top layer and to the bottom layer;
a second rib disposed between and connected to the top layer and the bottom layer;
a web connected to the first rib and connected to the second rib;
a total thickness that is less than or equal to about 32 mm; and
two or more air gaps in a perpendicular line between the top layer and the bottom layer;
wherein the multiwall sheet exhibits a U-value of less than or equal to about 2.3 W/m²K, and has an AgUT ratio of greater than or equal to about 0.168.

18. The multiwall sheet according to claim 17, wherein the ratio of the total thickness to the number of air gaps is greater than or equal to about 2.0 and less than or equal to about 2.5.

19. The multiwall sheet according to claim 18, wherein the multiwall sheet is formed from polycarbonate comprising an ultraviolet light absorber.

20. The multiwall sheet according to claim 17, wherein the multiwall sheet has a ratio of total thickness to U-value of greater than or equal to about 4.3.
